(19) United States
(12) Patent Application Publication
(10) Pub. No.: US 2023/0325777 A1
(43) Pub. Date: Oct. 12, 2023

(54) Position-Resolved, Broad Engagement, Candidate Matching System

(71) Applicants: Stuart Olsten, Milwaukee, WI (US); Michael A. Campion, Milwaukee, WI (US); William Rose, Milwaukee, WI (US)

(72) Inventors: Stuart Olsten, Milwaukee, WI (US); Michael A. Campion, Milwaukee, WI (US); William Rose, Milwaukee, WI (US)

(21) Appl. No.: 18/157,543

(22) Filed: Jan. 20, 2023

Related U.S. Application Data
(60) Provisional application No. 63/330,142, filed on Apr. 12, 2022.

(51) Int. Cl. G06Q 10/1053; G06Q 10/0631

(52) U.S. Cl. CPC G06Q 10/1053; G06Q 10/063112

(57) ABSTRACT

An apparatus for assisting in the evaluation of candidates provides an analysis of interview answers to extract personality traits and competencies. The apparatus provides a selection for target positions and provides benchmark data for those target positions providing an objective basis for evaluation of the extracted personality traits and competencies. A remote training application assists candidates in preparing themselves for interviews while also providing an extensive empirical data set for the benchmark data.

### CROSS REFERENCE TO RELATED APPLICATION

This application claims the benefit of U.S. Provisional Application 63/330,142 filed Apr. 12, 2022, and hereby incorporated by reference.

### STATEMENT REGARDING FEDERALLY SPONSORED RESEARCH OR DEVELOPMENT

### BACKGROUND OF THE INVENTION

The present invention relates to systems for facilitating the matching between candidates and positions, for example, employers and employees.

Identifying a candidate for a particular job opening can be costly, not only with respect to the immediate costs of finding and connecting with a pool of potential employees but also with respect to evaluating those employees with sufficient thoroughness to avoid significant costs to both the employer and employee when the employee is hired but ultimately proves to be a poor fit for the job.

Identifying a pool of employees and connecting with them is often done through employment ads, traditionally in a newspaper or the like but also now via various websites. These methods are relatively imprecise and can lead to the development of a large number of poorly matched applicants burdening the evaluation process or, when more focused, producing insufficient numbers of candidates and thus reducing the chance of finding the best fit for a job. The difficulties of conventional approaches are compounded by the challenge of accurately describing or understanding the requirements for the successful job applicant.

Once a pool of potential employees is identified, a human interviewer, and often several interviewers, may review the candidates. This approach burdens existing employees and hiring managers, and for this reason the number of interviews is usually sub optimal, with the number of candidates evaluated reduced by a coarse pre-filtering which dominates any subtlety in the selection of candidates that might be obtained with a person-to-person interview.

In order to avoid these problems, it is generally known to use machine learning or models to provide a prescreening of candidates. Such a prescreening, for example, looks at a text transcription of an interview or interview questions and extracts general characteristics of the candidates, for example, conscientiousness or openness to experience, that can be related to assumed requirements for the job. A disadvantage to this approach is that often the evaluator will not have a strong understanding of how these characteristics should be used to judge the candidate or predict a successful matching.

In order to avoid this problem, an outcome-based machine learning approach can be adopted with the machine learning system trained with interview content from previous candidates having demonstrated success (for example, being offered a job or having post-hire evidence of succeeding in this job). While this approach does not rely on the evaluator's understanding of the necessary candidate characteristics, it is constrained by the challenge of constructing specific models or machine learning engines for each different position type for generalizing among positions and thus loses accuracy.

Similar problems to those described above with respect to hiring also occurs in other situations such as students for undergraduate or graduate programs.

### SUMMARY OF THE INVENTION

The present invention provides a candidate evaluation system that avoids the difficulties associated with constructing multiple machine learning models for each different position or the need for the evaluator to accurately determine how candidate characteristics and competencies relate to particular positions. In this regard, the invention may evaluate applicants based on a set standardized traits and competencies and then provide benchmark traits and competencies linked to specific positions relevant to the interviewing process. These benchmark values inform the evaluator as to the importance of particular traits and competencies but eliminate the need for a large number of machine learning systems trained for each position. Providing guidance to the evaluator in the form of benchmark scores also provides transparency to the process that would not be obtained in a pure machine learning model.

In some embodiments, an interview training application can be provided to candidates to practice their interviewing skills. Data collected from the training application can be used to inform the benchmark scores and, with permission of the candidate, serve as a pool of potential candidates for schools and employers. Offering training improves the evaluation process by promoting candidates who are potentially good candidates but unfamiliar with interview practices.

More specifically, one embodiment of the present invention provides an apparatus for evaluating candidates for a target position having an evaluation module with an input for receiving interview data from a given candidate and a set of analysis engines analyzing the input to provide output scores for a set of competencies and personality traits based on the input. The evaluation module also provides a database of benchmark scores for competencies and personality traits each linked to a different of multiple target positions and an input for selecting, by an evaluator, an evaluator target position among the multiple target position. An output report generator produces an output report for the evaluator matching the output scores for the set of competencies and personality traits to the benchmark scores for correspond competencies and personality traits of the evaluator target position.

It is thus a feature of at least one embodiment of the invention to better relate general candidate characteristics and competencies to particular positions such as jobs or academic opportunities by providing benchmark values indicating the significance of particular characteristics and competencies to particular jobs. The benchmarking process provides improved transparency in the evaluation process and, in some embodiments, can avoid the costs and challenges of training of separate machine learning modules.

The evaluator target position may be employment opportunities or educational programs.

It is thus a feature of at least one embodiment of the invention to provide a system broadly applicable to matching individuals to opportunities.

The benchmark scores may be empirically derived from output scores of other candidates related to a target position matching the evaluator target position.

It is thus a feature of at least one embodiment of the invention to provide a broad statistical base giving the evaluator an understanding of the characteristics of the pool of potential applicants.

Alternatively or in addition, benchmark scores may be empirically derived from output scores limited to other candidates to whom the target position is offered based on the output scores.

It is thus a feature of at least one embodiment of the invention to provide benchmark scores related to likely success of the candidates.

The interview data may include responses to a predetermined set of interview questions, and the benchmark scores for competencies and personality traits linked to particular target positions use the same predetermined set of interview questions and the same set of analysis engines.

It is thus a feature of at least one embodiment of the invention to provide for standardized questions and analysis allowing accurate comparison of interview data and benchmark data over a wide range of occupations and educational opportunities.

The output report may display a quantitative representation of the output scores grouped with a quantitative representation of the benchmark scores.

It is thus a feature of at least one embodiment of the invention to provide transparent guidance to the evaluator who may see both the output scores and the benchmark scores as opposed to or in addition to normalizing the output scores.

The input for selecting the evaluator target position may provide target position categories and target position subcategories arranged within the target position categories.

It is thus a feature of at least one embodiment of the invention to provide extremely fine-grained occupational or educational opportunity distinctions.

In some embodiments, the invention may also include a training module having an input for selecting, by a practicing candidate, a practice target position among a plurality of target positions. An examination engine presents a set of practice interview questions to the practicing candidate and applies answers to the practice interview questions from the practicing candidate to a set of analysis engines to provide test output scores for a set of competencies and personality traits based on the answers. An output report generator provides an output report to the practicing candidate displaying the test output scores and guidance information for evaluating the test output scores and provides an input for receiving contact information for the practicing candidate providing permission by the practicing candidate for an evaluator to contact that practicing candidate with respect to job opportunities and to receive the test output scores.

It is thus a feature of at least one embodiment of the invention to improve the evaluation process by providing training opportunities to candidates who may have desirable traits and characteristics but are inexperienced with interviews. It is another feature of at least one embodiment of the invention to greatly increase the base of data for assessing candidates through the use of a training application.

The guidance information for competencies and personality traits of the practice target position maybe based on but not reveal the benchmark scores. In some cases, the guidance information maybe based on test output scores of other users of the training module linked to a related practice target position. In some cases, the output report groups the test output scores according to a predetermined importance of a score of the test output scores to a selection of candidates for the practice target position.

It is thus a feature of at least one embodiment of the invention to reduce an incentive for a practicing individual to tailor their answers to a desired occupation.

The output report may further provide interviewing tips indicating answer strategies for practice interview questions with respect to particular test output scores according to a comparison between the particular test output score and the corresponding benchmark score.

It is thus a feature of at least one embodiment of the invention to assist the practicing individual in identifying particular points of weakness and to provide general coaching.

The evaluation module may further include an input for receiving the answers to the practice interview questions and the practice target position from the training module to update the database of benchmark scores. In addition or alternatively, the evaluation module may include an input for receiving post-interview outcome data related to the answers to the practice interview questions by the practice candidate to update the database of benchmark scores.

It is us a feature of at least one embodiment of the invention to provide a broad base of empirical information both reflecting the applicant pool and the successful applicant pool for benchmarking the evaluation process

These particular objects and advantages may apply to only some embodiments falling within the claims and thus do not define the scope of the invention.

### BRIEF DESCRIPTION OF THE DRAWINGS

FIG. 1 is a simplified block diagram of an interview system providing for a central evaluation system linked to multiple remote training systems;

FIG. 2 is a functional block diagram of the evaluation system also supporting the remote training systems;

FIG. 3 is a flowchart of the processes executed by the interview system of FIG. 1 in conducting interviews;

FIG. 4 is an example screenshot showing a report prepared by the interview system for an evaluator providing benchmarks based on an input occupation;

FIG. 5 is an example, fragmentary, screenshot of an occupational selection window of FIG. 4;

FIG. 6 is a screenshot of a remote training system allowing for the entry of biographical data and permissions and a desired occupation;

FIG. 7 is a second screenshot of the remote training system similar to FIG. 6 providing an example question for a practice interview; and

FIG. 8 is a figure similar to FIGS. 6 and 7 showing an output training screen presented to the interview candidate for constructive feedback and training.

### DETAILED DESCRIPTION OF THE PREFERRED EMBODIMENT

### I. Evaluating Employment Candidates

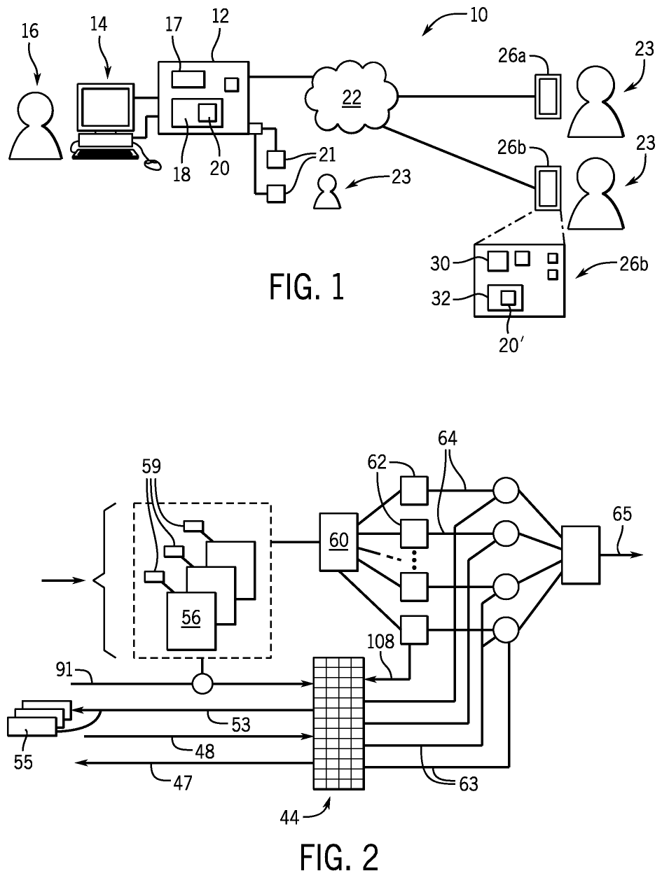

Referring now to FIG. 1, an apparatus for evaluating employment candidates 10 may in one embodiment provide for a central evaluation computer 12 communicating via a user interface 14 with an evaluator 16 for evaluating employee candidates.

The user interface 14, for example, may provide for a graphics computer monitor, keyboard, mouse, or the like, and the central evaluation computer 12 may comprise one or more electronic processors 17 communicating with electronic memory 18, the latter holding a stored program and data files 20 as will be described below.

The central evaluation computer 12 may in turn communicate with various additional input devices 21, for example, a camera, a microphone, a keyboard, and a separate graphic display to be used by an interview candidate 23 for conducting a contemporaneous local or remote interview and recording the same. For remote and possibly asynchronous interviews, the evaluation computer 12 may communicate over the Internet 22, cellular network, or the like, with one or more remote training devices 26a and 26b, for example, in the form of multifunction cellular telephones in the possession of other interview candidates 23. In that capacity, the remote training devices 26 may also provide for one or more processors 30 communicating with an electronic memory 32 holding a stored program and data files 20′ operating in conjunction with stored program and data files 20 as will be described below. The remote training devices 26 may also provide microphones, keyboards, and video cameras for recording practice or actual interviews as will be discussed in more detail below, and a touch screen for displaying questions and receiving answers.

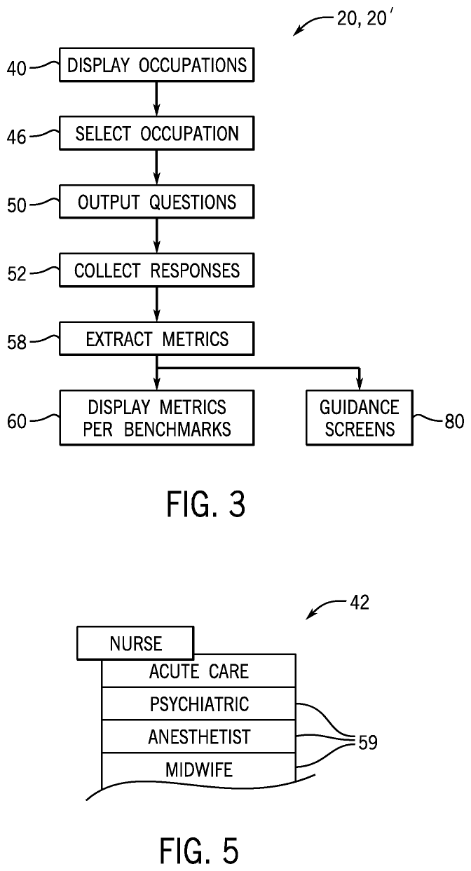

Referring now to FIGS. 2, 3, and 5, the programs and data files 20, 20′ may be executed to display an occupation menu 42 to the evaluator 16 to identify the relevant employment opportunity as indicated by process block 40 of FIG. 3. As shown in FIG. 5, in one embodiment, the menu 42 may provide a hierarchical organization having both occupation categories (such as nurse) and occupation subcategories indicating types of nurses (such as acute care nurses, nurse anesthesiologists, nurse midwives, etc.) allowing the evaluator 16 to select a category and subcategory for precise description of a target occupation. A standard text search feature may also be provided for particular categories and subcategories.

Referring specifically to FIG. 2, the potential occupations populating the occupation menu 42 may be contained in an occupation database 44 exposed to the devices per communication path 47 and receiving a selection of a particular occupation per communication path 48 (indicated by process block 46 of FIG. 3). This particular occupation can provide an index through the database 44 for matching benchmark data as will be described. The matching may be either at the category level (e.g., nurse) or at the subcategory level (e.g., acute care nurse).

As indicated by process block 50 of FIG. 5 and via the communication channel 53 of FIG. 2, a set of standard interview questions 55 may then be output as prompts for the collection of interview data. This outputting, for example, may be by means of user interface 14, allowing the evaluator 16 to ask questions directly to the interview candidate 23, or may be in written form either presented to the interview candidate 23 during an interview process from a display screen associated with input devices 21 of the computer 12 (not shown) or by the display screens on devices 26. The questions 55 may be keyed to the particular selected occupation by entry in the database 44 indexed to that particular occupation, or may be common questions across all occupations.

Responses by the interview candidate 23 to the questions 55 are collected, as indicated by process block 52 of FIG. 3 and arrow 91 of FIG. 2, and stored in a data file 56 linked to the selected occupation 59 and the particular interview candidate 23. The data file 56 will generally include all relevant interview information including biographical data, for example, educational background, grade point average, test scores, and years of experience and the like, as well as responses to more generalized questions, for example, relating to hypothetical situations, candidate experiences, attitudes, and the like. These generalized questions are designed to expose both personality traits of the candidate and competencies. The biographical information can be obtained through questions 55 or entered directly by the interview candidate 23 or by the evaluator 16 directly in the form without extensive text processing.

At process block 58, the data files 56 are provided to a preprocessor 61. The preprocessor 61 may perform standard speech-to-text conversion, translation, or other preprocessing steps like stemming and lemmatization to provide a common text file that can be provided to a set of analysis engines 62, each of which operate on the files to produce different output metrics 64.

A wide variety of analysis engines 62 may be used including machine learning models, natural language processing models, neural networks, or the like. Example analysis engines are described in U.S. patent application Ser. No. 16/847,348 filed Apr. 13, 2020, entitled: “System and Method for Evaluating Employment Candidates or Employees,” assigned to the assignee of the present application and hereby incorporated by reference. The different output metrics produced by the analysis engine 62 may include personality traits and competencies.

Example personality traits include those from the OCEAN personality framework including:
Openness to experience: The degree to which a person is open to new experiences and ideas.
Conscientiousness: The degree to which a person is organized, reliable, and hardworking.
Extraversion: The degree to which a person is outgoing, sociable, and assertive.
Agreeableness: The degree to which a person is cooperative, empathetic, and likable.
Neuroticism: The degree to which a person is prone to negative emotions such as anxiety, sadness, and moodiness.

Additional personality and psychological traits include:
Empathy: The ability to be aware of and understand the feelings and experiences of others.
Enthusiasm: Feelings of joy and excitement.
Proactiveness: The tendency to take initiative.
Self-Determination: The ability to feel in control of one's actions and is motivated by their own personal goals and values.
Resilience: The ability to adapt and cope with challenging or difficult situations, such as adversity, trauma, or stress.

Example competencies include:
Leading and Deciding: Takes action, leads, coordinates, sets objectives, develops, and facilitates others, takes responsibility, shows drive, completes work, makes decisions, influences, models, gains trust, and exhibits leadership traits.
Supporting and Cooperating: Helps others, assists and serves, cares for other people, focuses on the team, builds relationships, keeps others informed, listens, seeks understanding, mentors, promotes others, and is people oriented.
Interacting and Presenting: Acts professionally, shows respect, meets new people well, networks, speaks clearly, presents and demonstrates skillfully, influences others, challenges others, is comfortable in public, and is socially skilled.
Analyzing and Interpreting: Assesses situations quickly, asks questions, observes, reads, searches, reasons, learns readily, is highly knowledgeable, prepares, provides answers, trains others, values understanding, and thinks analytically.
Creating and Conceptualizing: Looks for and creates opportunities, welcomes change, seeks improvement, develops ideas, studies and researches, explores, challenges current situations or processes, formulates ideas for improvement, and is open to new insight.
Organizing and Executing: Plans and organizes work, focuses on the future and the end product, sets goals, gets work started, monitors progress, follows directions and procedures, is thorough, maintains, follows through, and delivers.
Adapting and Coping: Realizes need for change, is willing to try, seeks self-development and growth, supports changes, stays positive, prepares, manages, actively adapts, challenges when necessary, copes with stress, and maintains balance and control.
Enterprising and Performing: Is willing to work to achieve goals, wants to win, directs effort effectively, strives for success, is highly motivated, has confidence in ability, exhibits strength, completes responsibilities, builds, and has a can-do attitude.

When a natural language processing approach is used to implement the analysis engines 62, personality trait and competency dictionary files may be prepared, for example, being a comma-separated (CSV) text file having a first logical column being one with the traits or competencies mentioned above and whose remaining columns are words associated with said trade or competency. For example, the first row of the file might provide for “Leading and Deciding,” with the subsequent columns listing the words: “leadership,” “managing,” and so on and so forth. Evaluation of the interview data file 56 against the words of these dictionary files may be, in one example, performed using a TF-IDF (Term Frequency-Inverse Document Frequency) calculation to determine, on average, how common these terms are in the data file 56 based on the uniqueness of the words within the answers of the data file.

The output metrics of the analysis engines 62 are then linked to corresponding benchmark metrics 63 from the database 44 associated with the selected occupation 59. Generally, the corresponding benchmark metrics 63 are previously developed from the outputs of analysis engines 62 working on the data files 56 of other individuals associated with the selected occupation 59. In one embodiment, the benchmark metrics 63 measure people who have self-selected as being interested in that occupation whether they are ultimately hired or not and regardless of their success. As will be understood, this provides evaluator 16 with a sense of the potential pool of applicants and can be expressed, for example, by a number of statistical measures, for example, a median value or average value. Alternatively or in addition, the benchmark metric 63 may be limited to individuals who have had a positive post-interview experience, for example, a call back for a second interview or a positive hiring decision or post-hiring activity such as evaluations by supervisors, longevity in the job, sales metrics, or the like. Generally, this information may be obtained empirically as will be discussed below, but initially it may be prepared using skilled individuals making a predictive assessment of necessary characteristics.

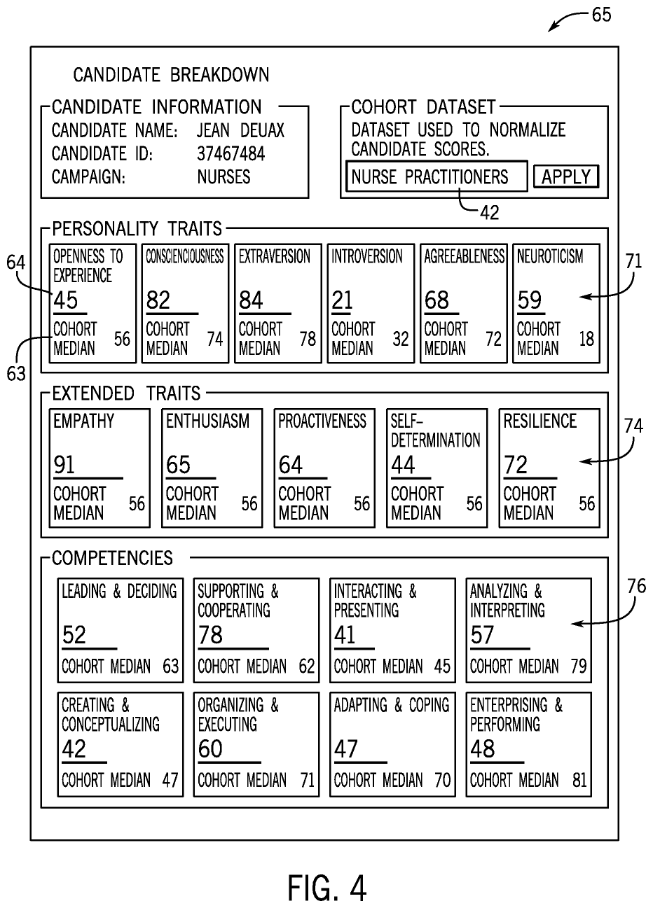

Per process block 60 and referring also to FIG. 4, these linked output metrics 64 and benchmark metrics 63 may be displayed in a candidate breakdown screen 65 to the evaluator 16 providing, for example, an output metric 64 in quantitative form positioned above a benchmark metric 63 for comparison purposes. This may be done for each of the personality traits 71, extended personality traits 74, and competencies 76. Alternatively it will be understood that the output metrics 64 may be normalized to the benchmark metrics 63 (for example, by dividing one by the other) and/or additional indications may be provided, for example, by coloring output metrics 64 that exceed the benchmark metrics 63 in a different color to highlight these situations versus situations where the output metrics 64 are less than the benchmark metrics 63.

By providing the benchmarks metrics 63, a deeper understanding of the necessary candidate qualities is obtained by the evaluator 16, for example, avoiding the tendency to simply total up the output metrics 64 to view them in a way that suggests that they are all equally important.

It will be appreciated that the selected occupation 59 per menu 42 need not match the occupation sought by the candidate 23 but may simply serve as a proxy for a type of candidate desired. This allows the evaluator 16 to consider a candidate for different positions (for example, a candidate for acute nursing for different types of nursing that may be open) or to evaluate candidates against different professions entirely, for example, evaluating nurses against customer service representatives when there is a desire to emphasize the characteristics necessary to work with customers or patients. In this respect, the selected occupation 59 may serve as a proxy for a type of individual.

When multiple candidates 23 are being interviewed, this process of process blocks 50-58 may be repeated to obtain the above-described output metrics 64 and benchmark metrics 63 for multiple individuals. Additional reports (not shown) can be prepared ranking the candidates 23, for example, according to these measurements.

Referring now to FIGS. 1, 2, 3, and 6, the same structure may be used to offer perspective candidates 23 the ability to practice interviewing skills and obtain useful feedback on those skills. In this case, the devices 26 may provide for an initial screen 72 allowing the individual to register by entering a name, desired occupation, other biographical information, and permission for data sharing as will be discussed below. Contact information may be automatically collected from the device 26 when permission is granted (for example, a phone number or email address). The occupation selection menu 42 may make of use of the occupations in the database 44 and thus be compatible with that database 44 when received at process block 46.

Upon completion of the data entry required by this screen by the prospective candidate 23, as indicated by FIG. 7, a new screen is provided displaying set of questions to be output per process block 52 to the candidate 23 either by text or audio or an avatar-type system intended to reflect or simulate an actual interview. The data file 56 may be acquired by a microphone, text typing, or video through the device 26 per process block 52 and this operation repeated for each question provided from the database 44 to the remote device 26.

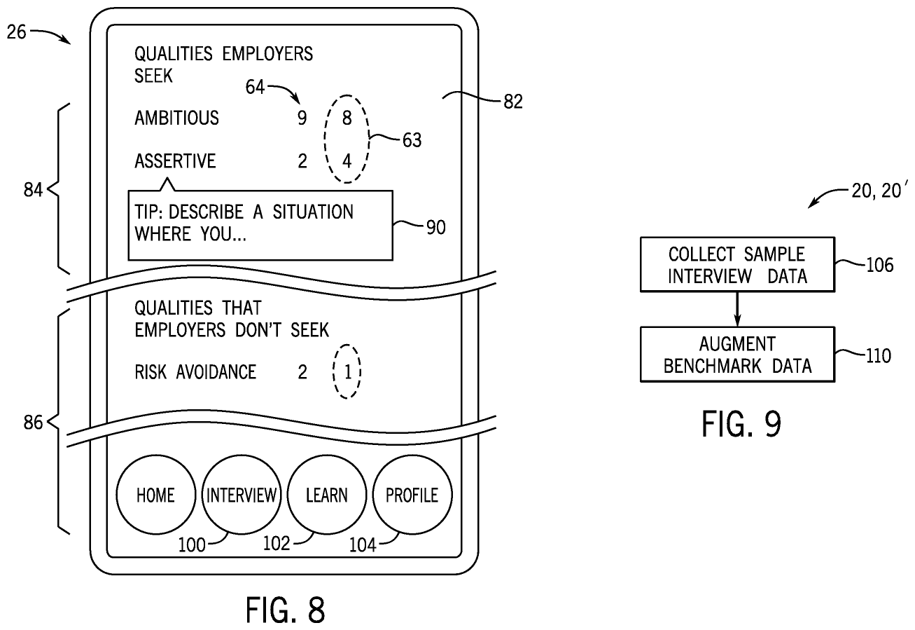

Upon completion of the interview at process block 58, output metrics 64 are again extracted and the program 20, 20′ proceeds to process block 80 to provide a review screen 82 shown in FIG. 8 offering feedback to the candidate 23. The review screen 82 may provide for benchmark metric 63, for example, representing an average output metric 64 by other individuals interested in the particular occupation allowing the candidate 23 to assess their relative position among their peers. More generally, however, in at least one embodiment, the review screen 82 of the training application does not reveal the benchmark metrics 63 directly, instead generally providing for a first and second grouping 84 and 86 of output metrics 64 indicating the output metrics 64 of the candidate 23 that are considered favorable or unfavorable, respectively, by the employer in this context. The unfavorable output metrics 64 may be renamed to indicate this relative status.

Using the review screen 83, the candidate 23 can work on improving their score without encouraging the candidate 23 to fabricate answers to beat a particular benchmark metric 63. For particular output metrics 64 where the individual's score is substantially below the benchmark metrics 63 (for example, by a predetermined percentage or the like), the review screen 82 may provide overlay tips 90 offering general guidance of a type provided by a career counselor or the like endeavoring to present the candidate 23 in the best possible light. The training application intends to remove differences between candidates based simply on differences in interviewing skill as opposed to underlying personality traits and competencies.

Referring now to FIG. 9, when permission has been granted, programs 20, 20′ may operate to harvest the latest data file 56 produced by a practice session, per process block 106 and as shown in FIG. 2 per arrow 91, to provide a new data file 56. This data file 56 may be processed through the preprocessor 61 and the analysis engines 62 to provide output metrics that may be routed back to the database 44 per arrow 108 and combined with that database 44 to generate new benchmark outputs 63 with a larger data foundation per process block 110. In some cases, the data file 56 from the devices 26 may be augmented with outcome data, for example, when the interview candidate 23 is hired or subsequently appraised allowing outcome-based data to also be enrolled in the database 44 as was discussed above.

Voluntary collection of this data from these practice sessions provides the necessary breadth of data collection needed to populate data for many specific different occupations thus greatly improving the resolution of the system.

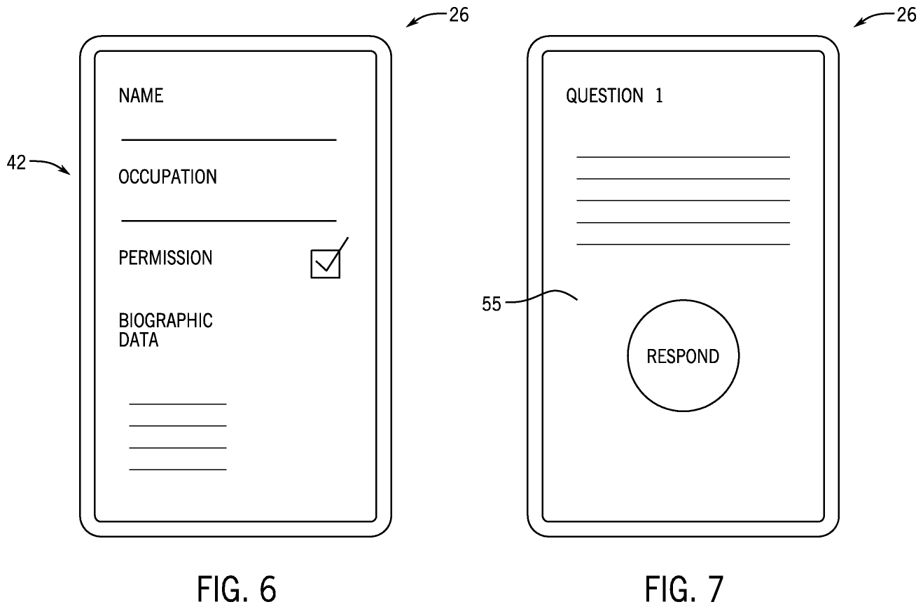

The device 26 may also display to the interview candidate 23 a button 100 to initiate a new interview that will replace the last interview, a learning button 102 which provides general advice for conducting interviews targeted toward the interview candidate 23, and a profile button 104 which allows the user to revise his or her profile and biographical data per FIG. 6.

The data file 56 from the devices 26, when permission is granted by the candidate 23, may also be preserved with contact information to provide a searchable database for potential candidates for a job that may be used by the evaluator 16 to greatly increase the pool of potential candidates for a particular job, thereby providing an important benefit in improving the hiring marketplace for both employers and employees.

### II. Evaluating Student Applicants

While the above example embodiment has described the invention in the context of matching employers and employees, it will be understood from this discussion that the same principles and constructions can be applied to matching students to educational programs, where the students stand in the position of the job applicants and the educational programs stand in the position of occupations. Thus, for example, at process blocks 40 and 46 of FIG. 3 and in the screen shot of FIG. 6, a list of educational programs may be displayed and selected among instead of occupations. For example, the categories of graduate business (MBA), graduate physicians assistant (PA), or undergraduate, may be provided with subcategories representing specializations within these categories, for example, undergraduate majors of engineering, fine arts, history, English, and the like. This difference may also be reflected in the categories and subcategories depicted in FIG. 5 and will characterize the data in the database 44 shown in FIG. 2 to the extent that the sources of the data are students rather than potential employees. In this regard, the benchmark metrics 63 may be provided for a variety of different categories which may be displayed simultaneously in the candidate breakdown screen 65 or selected by the individual, including benchmark outputs that consider:
all applicants for the incoming class of a particular school;
applicants for the particular program category or subcategory of a particular school;
applicants across all schools;
applicants in a particular date range;
former applicants who have obtained particular post-admission achievements such as passing state boards and licensing tests, obtaining particular grades on entrance examinations such as the graduate record examination; and
applicants who complete their field of study within a predetermined time (for a particular school or nationally).

In other respects the features described above will also apply to evaluating student applicants.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom”, and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including”, and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a computer” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An apparatus for evaluating candidates for a target position comprising:
an evaluation module providing:
an input for receiving interview data from a given candidate;
a set of analysis engines analyzing the input to provide output scores for a set of competencies and personality traits based on the input;
a database of benchmark scores for competencies and personality traits each linked to a different of multiple target positions;
an input for selecting, by an evaluator, an evaluator target position among the multiple target position; and
an output report generator providing an output report to the evaluator matching the output scores for the set of competencies and personality traits to the benchmark scores for corresponding competencies and personality traits of the evaluator target position.

2. The apparatus of claim 1 wherein the evaluator target position is selected from the group consisting of an employment opportunity and an educational program.

3. The apparatus of claim 1 wherein the benchmark scores are empirically derived from output scores of other candidates related to a target position matching the evaluator target position.

4. The apparatus of claim 2 wherein the benchmark scores are empirically derived from output scores limited to other candidates to whom the target position is offered based on the output scores.

5. The apparatus of claim 1 wherein the interview data includes responses to a predetermined set of interview questions, and wherein the benchmark scores for competencies and personality traits linked to particular target positions use a same predetermined set of interview questions and the same set of analysis engines.

6. The apparatus of claim 1 wherein the output report displays a quantitative representation of the output scores grouped with a quantitative representation of the benchmark scores.

7. The apparatus of claim 1 wherein the input for selecting the evaluator target position provides target position categories and target position subcategories arranged within the target position categories.

8. The apparatus of claim 1 further including:
a training module providing:
an input for selecting, by a practicing candidate different from the evaluator, a practice target position among a plurality of target positions;
an examination engine presenting a set of practice interview questions to the practicing candidate and applying answers to the practice interview questions from the practicing candidate to a set of analysis engines to provide test output scores for a set of competencies and personality traits based on the answers;
an output report generator providing an output report to the practicing candidate displaying the test output scores and guidance information for evaluating the test output scores; and
further including an input for receiving contact information for the practicing candidate providing permission by the practicing candidate for an evaluator to contact that practicing candidate with respect to job opportunities and to receive the test output scores.

9. The apparatus of claim 8 wherein the input for selecting the practice target position provides target position categories and target position subcategories arranged within the target position categories.

10. The apparatus of claim 8 wherein the guidance information for competencies and personality traits of the practice target position is based on but does not reveal the benchmark scores.

11. The apparatus of claim 8 wherein the guidance information is based on test output scores of other users of the training module linked to a related practice target position.

12. The apparatus of claim 8 wherein the output report groups the test output scores according to a predetermined importance of a score of the test output scores to a selection of candidates for the practice target position.

13. The apparatus of claim 8 wherein the output report further provides interviewing tips indicating answer strategies for practice interview questions with respect to particular test output scores according to a comparison between the particular test output score and the corresponding benchmark score.

14. The apparatus of claim 8 wherein interview data includes responses to a predetermined set of interview questions that also provide the practice interview questions.

15. The apparatus of claim 8 wherein the analysis engines of the training module are a same as the set of analysis engines of the evaluation module.

16. The apparatus of claim 8 wherein the evaluation module further includes an input for receiving the answers to the practice interview questions and the practice target position from the training module to update the database of benchmark scores.

17. The apparatus of claim 8 wherein the evaluation module further includes an input for receiving post-interview outcome data related to the answers to the practice interview questions by the practice candidate to update the database of benchmark scores.
